(19) United States
(12) Patent Application Publication
(10) Pub. No.: US 2020/0387111 A1
(43) Pub. Date: Dec. 10, 2020

(54) TIMEPIECE

(71) Applicant: CAST WATCHES LIMITED, Foxhall Ipswich Suffolk (GB)

(72) Inventors: Hayley FRASER-WEBB, Ipswich, Suffolk (GB); Cassie BENDALL, Ipswich, Suffolk (GB); Bob HATTRELL, Ipswich, Suffolk (GB)

(73) Assignee: CAST WATCHES LIMITED, Foxhall Ipswich Suffolk (GB)

(21) Appl. No.: 16/499,150

(22) PCT Filed: Mar. 28, 2018
(86) PCT No.: PCT/GB2018/000053

§ 371 Date: Sep. 27, 2019

(30) Foreign Application Priority Data
Mar. 28, 2017 (GB) 1704918.0

(51) Int. Cl. G04B 19/10; G04B 19/14; G04B 45/00

(52) U.S. Cl. CPC G04B 19/10; G04B 47/046; G04B 45/0092; G04B 19/14

(57) ABSTRACT

The present invention relates to a timepiece comprising: a housing (104) formed of a back plate (126), a side wall extending around the periphery of said back plate to form a rim (105), and a substantially transparent cover (102) extending across said rim (105) to form an enclosure; a horological mechanism mounted within said housing (104) adjacent to said back plate (126) and a time display means coupled to said horological mechanism by means of a shaft (116) and visible through said transparent cover (102); a face assembly including a tray (132) and a faceplate (136), the tray (132) comprising a substantially rigid base and having an elongate slot (136a) therein that extends from an open end at a peripheral edge of the base to a generally central location thereof, the slot (136a) having a width substantially equal to, or greater than, the diameter of said shaft (116), the faceplate (138) having a corresponding elongate slot (136b) therein and being configured to be received on said base such that their respective elongate slots (136a, 136b) are aligned; wherein the rim (105) of said housing includes an opening (130) therein configured to slidably receive into and remove from the housing (104), said tray (132) including a said faceplate (138), such that said shaft (116) is accommodated within said aligned slots (136a, 136b) and said faceplate (138) is substantially parallel to said cover (102); the time piece further comprising means for releasably fixing said face assembly within said housing.

### CROSS-REFERENCE TO RELATED APPLICATIONS

This application is a U.S. National Stage Application of International Application No. PCT/GB2018/000053, filed Mar. 28, 2018, which claims priority from GB Patent Application No. 1704918, filed Mar. 28, 2017, the entire contents of which are hereby incorporated by reference in their entirety.

### FIELD OF THE INVENTION

This invention relates generally to a timepiece, such as a wrist watch, wherein the face thereof is replaceable and interchangeable, and to a face assembly for such a timepiece.

### BACKGROUND OF THE INVENTION

It is becoming increasingly popular to enable the provision of customizable timepieces, particularly wrist watches. Indeed, it has long been known for a consumer to be able to customize a wrist watch by providing a personal face design or selecting from a number of optional face designs to be fitted onto the timepiece at the time of manufacture/assembly.

It has, more recently, become highly desirable to enable a user to customize their own watch, depending upon, for example, what they are wearing or personal preference on any given day. So-called smart watches are known, which have a digital face such that the user can download or upload any desired image/design thereto and, thereby, change the face design at will.

Watches having a face that is physically replaceable and/or interchangeable are also known. Many of these designs facilitate such replacement/interchangeability by providing a housing that opens up, such that the face therein can be removed and a new one inserted. However, repeated use of this facility leaves the horological mechanism (and other elements of the watch) vulnerable to damage and ingress of moisture or debris, which can shorten its lifespan. Furthermore, the face replacement process is fiddly, and can be very time consuming, and is also such that it is relatively easy for a user to incorrectly align the new face within the watch housing.

U.S. Pat. No. 5,793,710 describes an arrangement which seeks to address at least some of these issues. A watch is described comprising a housing having a back plate, peripheral rim and transparent cover. A horological mechanism is provided in the housing, adjacent the back plate, and a time display means is visible through the transparent cover, wherein the time display means and the horological mechanism are coupled together by means of a shaft. A face, carrying a design, is mounted on the shaft between the horological mechanism and the time display means. The face is formed of a resiliently elastic material having a central aperture and a slit that runs from the aperture to a peripheral edge of the face. A slot is provided in the rim of the housing through which a face can be removed and/or inserted, using the slit therein.

However, there are a number of issues associated with this. Firstly, the fact that the face must be quite flexible (in order to enable the edges of the slit to flex sufficiently to accommodate the shaft during insertion/removal thereof), it can be quite difficult to actually perform the required insertion operation without causing deformation of the face. Furthermore, it is difficult to ensure that the face is inserted in the correct orientation. No integral retention means are provided to retain the face within the housing, such that additional locking/unlocking functionality is required to be provided. Still further, and depending on the relative “rigidity” of the flexible plate, repeated replacement/interchanging operations can cause damage to the shaft of the horological mechanism.

### SUMMARY OF THE INVENTION

Aspects of the present invention seek to address at least some of these issues and, in accordance with a first aspect of the present invention, there is provided a timepiece comprising:

a housing formed of a back plate, a side wall extending around the periphery of said back plate to form a rim, and a substantially transparent cover extending across said rim to form an enclosure;

a horological mechanism mounted within said housing adjacent to said back plate and a time display means coupled to said horological mechanism by means of a shaft and visible through said transparent cover;

a face assembly including a tray and a faceplate, the tray comprising a substantially rigid base and having an elongate slot therein that extends from an open end at a peripheral edge of the base to a generally central location thereof, the slot having a width substantially equal to, or greater than, the diameter of said shaft, the faceplate having a corresponding elongate slot therein and being configured to be received on said base such that their respective elongate slots are aligned;

wherein the rim of said housing includes an opening therein configured to slidably receive into and remove from the housing, said tray including a said faceplate, such that said shaft is accommodated within said aligned slots and said faceplate is substantially parallel to said cover;

the time piece further comprising means for releasably fixing said face assembly within said housing.

In an exemplary embodiment, the elongate slot in said base of said base of said tray may extend from said open end at a peripheral edge to a closed end at a substantially central location thereon. In this case, the elongate slot in said faceplate of said face assembly may also extend from an open end at a peripheral edge to a closed end at a substantially central location thereon, the shape and principal dimensions of said faceplate and said base being substantially the same.

Optionally, the timepiece includes at least one guide for guiding said face assembly into and out of said enclosure. The guide may comprise at least one elongate ridge on one of said tray and said back plate, and at least one corresponding elongate groove in the other of said tray and said back plate, wherein, in use, said ridge is received in said groove to guide sliding movement of said tray into or out of said housing. In one exemplary embodiment of the invention, the ridge may be formed on a lower surface of said tray, when the timepiece is oriented for use, and said groove is formed in an upper surface of said back plate. The guide may comprise a pair of substantially parallel, spaced apart ridges on one of said tray and said back plate and a pair of substantially parallel, spaced apart corresponding elongate grooves in the other of said tray and said back plate.

The tray may be provided, at a peripheral edge substantially opposite said open end of said slot, with a rim that extends around a portion of the periphery of said base. In this case, the rim of said tray may be configured to close said opening in said rim of said housing when said face assembly is fully inserted therein. Optionally, the rim of said tray may be formed of a resiliently flexible material and said rim of said housing is profiled to receive said rim of said tray such that it is retained therein by means of an interference fit.

The tray may include, at a peripheral edge of said base adjacent to said open end of said slot, at least one engaging means configured to releasably engage with said rim of said housing when said face assembly is fully inserted into said housing, the timepiece further comprising external release means for releasing said engaging means and allowing the face assembly to be removed from said housing. In this case, the engaging means may comprise one or more tooth members, and wherein an inner surface of said rim of said housing is provided with one or more corresponding recesses configured to receive said tooth member(s) therein when said face assembly is fully inserted within said housing. The rim of said housing may include an aperture adjacent said engaging means when said face assembly is fully inserted in said housing, said aperture extending through said rim of said housing and being configured to receive a tool for pushing said face assembly in the direction of said opening and, thereby, releasing said face assembly for removal from the housing.

In an exemplary embodiment, the timepiece may further comprise an intermediate plate, located between said back plate and said face assembly, said intermediate plate comprising a substantially planar surface and having a generally central opening therein for accommodating at least a portion of said horological mechanism. The intermediate plate may further comprise a groove or recess for accommodating a control member that is coupled between said time display means and an external location on said housing.

In an exemplary embodiment, the faceplate may comprise a substantially rigid material on which a design is printed or otherwise provided.

In accordance with another aspect of the present invention, there is provided a face assembly for a timepiece substantially as described above, comprising a tray and a faceplate, the tray comprising a substantially rigid base and having an elongate slot therein that extends from an open end at a peripheral edge of the base to a generally central location thereof, the slot having a width substantially equal to, or greater than, the diameter of said shaft, the faceplate having a corresponding elongate slot therein and being configured to be received on said base such that their respective elongate slots are aligned.

### BRIEF DESCRIPTION OF THE FIGURES

FIG. 1 is a schematic exploded view of a watch body according to one exemplary embodiment of the present invention;

FIGS. 2A to 2E are schematic top perspective diagrams showing the replaceable watch face assembly according to one exemplary embodiment of the present invention, with the watch body of FIG. 1;

FIG. 3 is a schematic diagram showing a front perspective view of the watch of FIGS. 1-2E, according to one exemplary embodiment of the present invention;

FIG. 4A and 4B are schematic top cross-sectional diagrams showing the replaceable watch face assembly of FIGS. 1-2E; and

FIG. 5 is a close up view of the interference fit mechanism of the replaceable watch face assembly of FIGS. 1-2E.

### DETAILED DESCRIPTION

The present invention extends to a faceplate for a face assembly substantially as described above.

These and other aspects of the present invention will be apparent from the following specific description, in which embodiments of the present invention are described, by way of examples only, and with reference to the accompanying drawings.

Throughout the following specific description, the exemplary embodiment of the present invention is described in one preferred orientation where the face of the timepiece is facing upwards. Directional descriptors such as “upper”, “front”, “reverse”, “underneath”, etc. refer to the described embodiment when in the preferred orientation, however it will be understood by those skilled in the art that the timepiece may not always necessarily be in the preferred orientation, and therefore the directional descriptors will change accordingly.

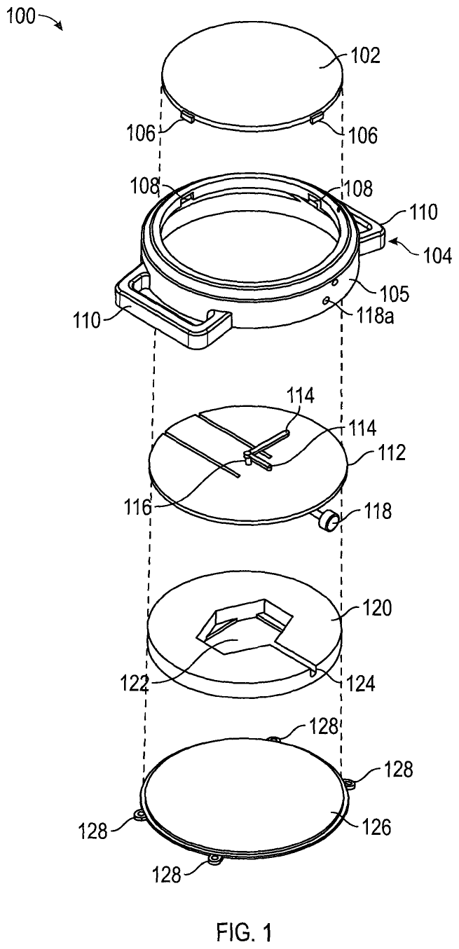

Referring to FIG. 1 of the drawings, according to one exemplary embodiment of the present invention, a watch body 100 (excluding a face assembly) is illustrated in an exploded view so as to display each component of the watch body separately. A transparent window 102, or crystal, is shaped and configured to fit within the main housing 104 of the watch. The window 102 may typically be constructed from glass, acrylic, or a mineral crystal and is designed to be fitted permanently within the main housing 104. In the illustrated example, the main housing 104 comprises a circular (peripheral) band or rim 105 having a thickness of approximately 2-7 mm, the inner edge of which is stepped. The stepped inner surface provides an edge on which the window 102 can rest. The window 102 fits within the outer edge of the main body 104 and comprises a plurality of teeth 106 spaced evenly around the circumference of the window 102. The teeth 106 correspond to a plurality of indents around the inner surface of the circular loop 105. During assembly, the window 102 can be pushed into the housing 104 and the teeth 106 snap fit into the corresponding indents 108 to hold the window 102 in place.

The housing 104 also has a pair of lugs 110 spaced substantially directly opposite each other on the outer circumferential edge of the housing 104. The lugs 110 are generally rectangular shaped, and define an enclosed aperture for accommodation of straps. Such straps are known in the art and may be constructed from metal, leather, plastic, or other material; however the invention is not intended to be limited in this regard. The housing may be comprised of any material suitable for watches, for example, wood, plastic, metal and/or a combination of materials, and the present invention is not intended to be limited in this regard.

The watch facia 112 is shaped and configured to fit within the housing 104, and therefore, according to this particular exemplary embodiment, is generally circular in shape with a diameter just smaller than that of the inner surface of the circular loop 105. Large and small hands 114 are fitted to a shaft 116 which protrudes through the centre of the facia 112. The watch may include hour, minute and/or second hands and these may move in a ticking or sweeping motion, depending on the movement of the watch, however the invention is not intended to be limited in this regard. The movement of the watch (not shown) is fitted to the underneath of the facia 112. The shaft 116 extends through the facia 112 to be fixedly coupled to the movement. A crown 118 protrudes from underneath the facia 112 and is communicably coupled to the movement of the watch. When assembled, the crown 118 extends through the circumferential edge of the circular loop 105, through aperture 118a which is spaced equidistant from the handles 110 on one side of the circular loop 105, allowing the user to adjust the hands of the watch, as is typical of watches.

The movement of the watch may be any suitable movement as is known in the art. In this particular exemplary embodiment, the movement is a Ronda™ movement which is hexagonal shaped, however other suitable movements may be used, and the present invention is in no way intended to be limited in this regard. A disk 120 for holding the movement in place fits beneath the facia 112 and comprises a movement-shaped (in this case, generally hexagonally-shaped) aperture 122 at the position where the movement is located (in this case, generally centrally). A channel 124 having a semi-circular cross section, for receiving the crown 118 shaft extends from the edge of the disk 120 radially inwardly, and meets the aperture 122. When assembled the disk 120 should be oriented such that the channel 124 aligns with the aperture 118a.

Finally, a clamping plate or back plate 126 provides the base of the watch body 100. The clamping plate 126 is almost equal in diameter to the housing 104. The plate 126 comprises four equally spaced screw holes 128 which protrude from the circumferential edge of the clamping plate 126. These screw holes 128 correspond to screw holes in the underside of the circular loop 105 (not shown). The clamping plate 126 is screwed onto the bottom of the circular loop 105, and provides the necessary pressure to hold the other components within the watch body 100.

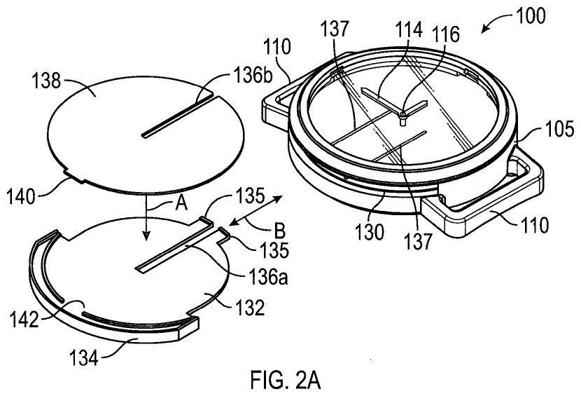

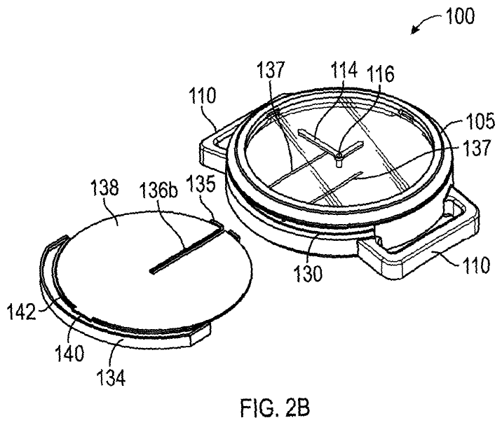

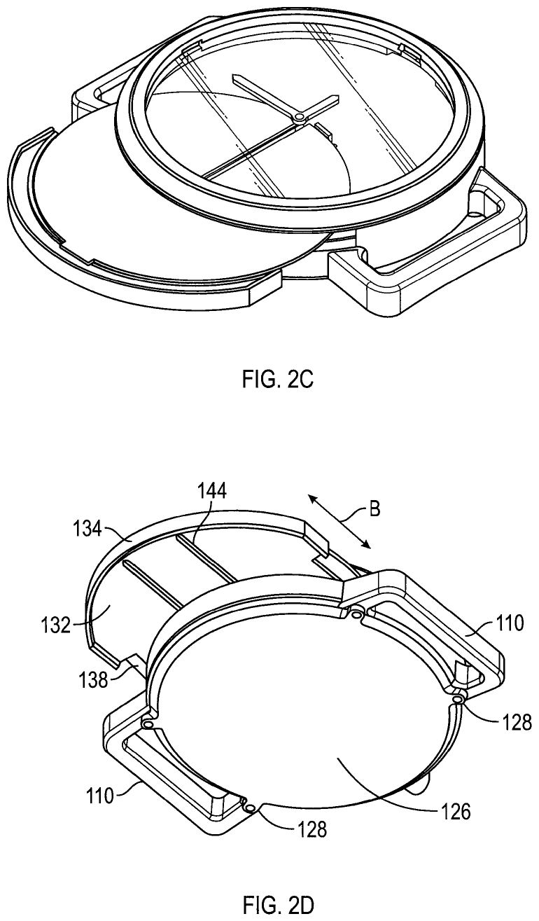

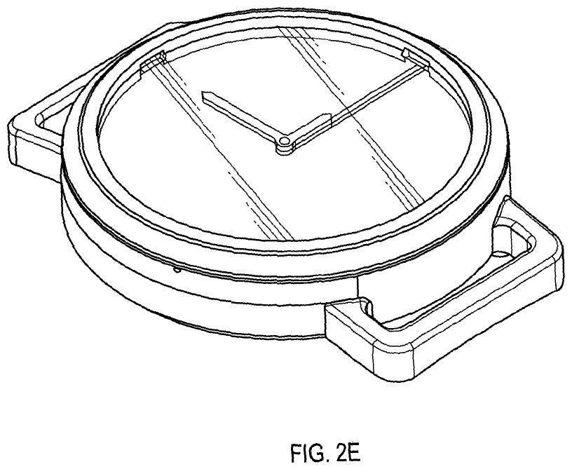

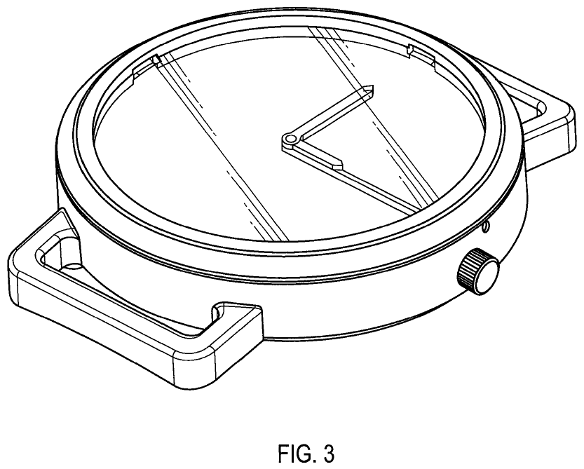

Referring now to FIGS. 2A-2E of the drawings, the watch body 100 is illustrated in the assembled configuration, wherein the facia 112 and the holding disk 120 are bound in the circular loop 105 by the window 102 and the clamping plate 126. An elongate slot 130 is provided in the housing rim 105 that extends circumferentially on one side between the lugs 110, i.e. extending along approximately one third to one half of the perimeter of the housing rim 105. The slot 130 extends fully through the thickness of the rim 105, to allow a face assembly, having the same diameter as the facia 122 and movement holding disk 120, to fit through.

The face assembly comprises a tray 132 and a faceplate 138. The tray 132 is comprised from a thin, generally disc-shaped piece of rigid material, and configured to fit through the slot 130. The tray 132 has a peripheral lip 134 partially along one side which is dimensionally similar to the slot 130. The lip 134 is of substantially equal thickness and curvature (i.e. cross-section) to the rim 105. The rest of the tray, though still generally circular, has a smaller radius of curvature. At the point around the edge of the tray 132 generally opposite the centre of the lip 134, two protruding teeth 135 extend from the peripheral edge of the tray 132, defining a slot 136a therebetween. The teeth 135 have slightly upwardly protruding inner edges, and may be flat or rounded at the leading surface. The slot 136a is wide enough to receive the shaft 116 centrally located in the facia 112 (without deformation) and extends from the edge of the tray 132 to the centre of the tray 132. The tray 132 is configured to be inserted in and removed from the aperture 130 (as shown by arrow B), wherein the slot 136a allows the tray to move over the facia 112 without any need to alter or move the shaft 116. A pair of grooves 137 on the facia 112, which extend in the direction parallel to the movement of the tray 134, help to guide the tray to ease the process of aligning the slot 136a with the shaft 116. This advantageously minimises undesired contact between the tray 132 and the shaft 116 thus reducing the risk of wear and damage.

The removable watch faceplate 138 is circular in shape, and of a diameter close to or equal to the facie 112 and movement holding disk 120. The faceplate 138 comprises a slot 136b, which is slightly thinner than the slot 136a in the tray 132 however still wide enough to receive the shaft 116 without damaging it (and without deformation). The slot 136b extends from a point at the edge of the faceplate 138 to the centre. The faceplate 138 further comprises a tab 140 directly opposite the point on the edge of the faceplate 138 where the slot 136b begins. This tab 140 protrudes just past the perimeter of the faceplate 138, and extends for a few millimetres around the edge. The tab 140 corresponds to a gap 142 in the lip 134 of the tray 132. The user prints or otherwise transfers their desired design onto the faceplate 138. The faceplate 138 can be placed on the tray 132 when the tray 132 is not within the watch body 100, shown in particular in FIG. 2A at arrow A. The faceplate 138 can only be placed correctly when the slots 136a, 136b are aligned. This is enabled by the tab 140 which will only allow the faceplate 138 to lie flush with the tray 132 if the tab 140 is aligned with the gap 142. The upwardly protruding edges of the teeth 135 help stop the faceplate 138 from dislodging or falling forwardly out of the tray 132 (forwardly being in the direction of movement when the tray 132 is being inserted).

This advantageously prevents the user from forcing a misaligned faceplate 138 into the watch body 100, therefore minimising damage to the shaft 116 and, ultimately, the movement. This is also facilitated by the alignment grooves 137 on the facia 112. Referring in particular to FIG. 2D of the drawings, the underneath of the watch body 100 and tray 132 are illustrated. Downwardly protruding ridges 144 extend along the bottom of the tray 132 in a directional parallel to the movement of the tray (i.e. arrow B). The ridges 144 are spaced apart and align with the grooves 137 to allow a smooth transition of the tray 132.

FIGS. 2A through to 2E illustrate chronologically how the assembly would look when inserting the tray 132 into the watch body 100, with a faceplate 138 placed on the tray 132. FIG. 2E illustrates the assembly having the tray 132 and faceplate 138 fully inserted. The outer surface of the lip 134 lies flush with the outer surface of the housing rim 105 and no other buttons or locking mechanisms can be seen from the outside, resulting in an improved appearance of the watch.

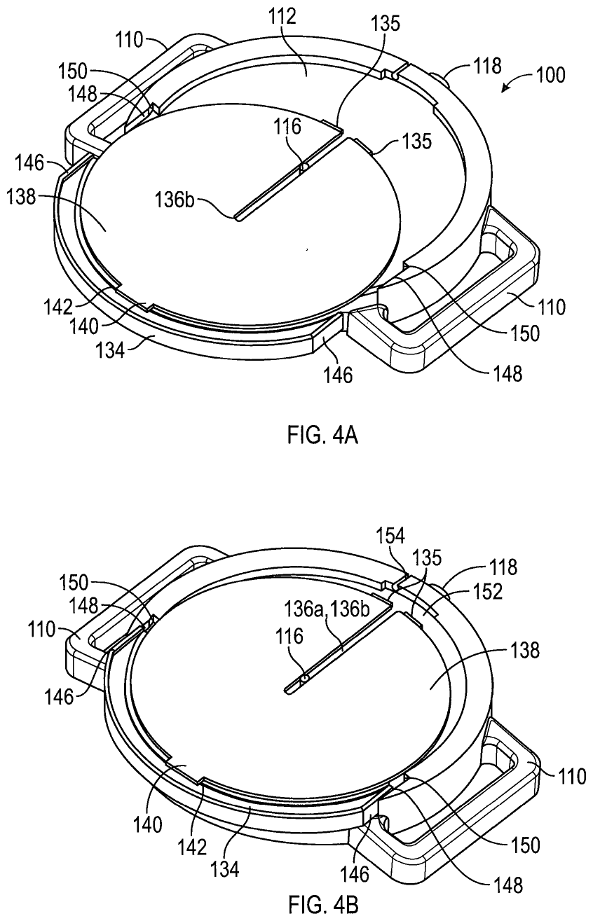

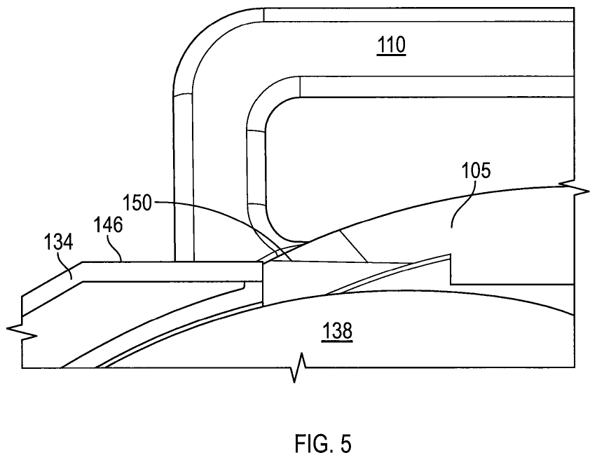

Referring now to FIGS. 4A, 4B and 5 of the drawings, a horizontal cross-section of the assembly is illustrated. The cross-section is taken at a point just above where the faceplate 138 would sit when in the fully inserted position, such that the slot 130 appears as a gap in the housing rim 105. The lip 134 of the tray 132 has a pair of flat walls 146 at either end of the lip 134. The flat walls 146 are parallel to the direction of movement of the tray 134. The vertical side walls 148 of the slot 130 are drafted vertically, such that the slot 130 width at the top of the slot 130 is a few millimetres smaller than the slot 130 width at the bottom of the aperture. The drafted walls 148 also extend parallel to the direction of movement of the tray 132. When inserting the tray 132, the flat walls 146 run against the drafted walls 148. The pressure on the flat walls 146 from the drafted walls 148 prevents the tray 132 from falling out the housing 102 by an interference fit. A triangular notch 150 is cut out from the inner rim 105 at the inner end of the drafted walls 148. Where the lip 134 material is slightly elastic, the pressure on the flat walls 146 will cause the end of the lip 134 to deform slightly, therefore the space 150 allows the lip 134 to bend a little outwardly, releasing the pressure on the material and thereby facilitating an interference fit. A close up of the mechanism can be seen in FIG. 5 of the drawings.

Referring now in particular to FIG. 4B, there is an indent 152 on the inner surface of the housing rim 105. This is configured to accommodate the teeth 135 on the tray 132, thus allowing the teeth to be hidden when the tray 132 is fully inserted. A small circular opening 154 through the wall of the rim 105 is positioned within the indent 152 and directly aligned with at least one of the teeth 135. To release the tray 132, the user inserts a rigid tool, such as a pin, or the end of a paperclip, through the small circular aperture 154 to push directly on the leading edge of at least one of the teeth 135. The pressure applied is enough to overcome the frictional fit between the flat walls 146 of the lip 134 and the drafted walls 148 of the slot 130, thus releasing the tray. The user may simply then pull on the lip to fully remove the tray 132.

In the above-described exemplary embodiment of the present invention the watch body 100 and the tray 132 and faceplate 138 are shown to be generally circular in shape. However, it will be apparent to those skilled in the art that the above embodiment may be adapted for rectangular watch faces, for example, or other shapes as so desired, and the invention is not intended to be limited in this regard. Furthermore, the exemplary embodiment described above is for wrist watches, however adaptations can easily be made to include pocket watches, wall clocks, standing clocks, fob watches and other known timepieces. Additionally, the above described embodiment relates to an analogue-style timepiece, having hands and a shaft which is connected to a movement. It will be apparent to those skilled in the art that modification of the above described-embodiment can be made such that it is suitable for a digital and/or combination timepiece, for example, by incorporating further apertures through the face assembly.

The invention provides the user with the ability to easily change and replace the face of their timepiece by having custom made faces created. The interference fit provides a way of allowing the user to know that their preferred face is safely locked into place unless and until they perform the necessary action to release it.

It will be apparent to a person skilled in the art, from the foregoing specific description, that variations and modifications to the above described exemplary embodiment may be made without departing from the scope of protection as defined by the appended claims.

1. A timepiece comprising:
a housing formed of a back plate, a side wall extending around the periphery of said back plate to form a rim, and a substantially transparent cover extending across said rim to form an enclosure;
a horological mechanism mounted within said housing adjacent to said back plate and a time display means coupled to said horological mechanism by means of a shaft and visible through said transparent cover;
a face assembly including a tray and a faceplate, the tray comprising a substantially rigid base and having an elongate slot therein that extends from an open end at a peripheral edge of the base to a generally central location thereof, the slot having a width substantially equal to, or greater than, the diameter of said shaft, the faceplate having a corresponding elongate slot therein and being configured to be received on said base such that their respective elongate slots are aligned;
wherein the rim of said housing includes an opening therein configured to slidably receive into and remove from the housing, said tray including a said faceplate, such that said shaft is accommodated within said aligned slots and said faceplate is substantially parallel to said cover;
the time piece further comprising means for releasably fixing said face assembly within said housing.

2. A timepiece according to claim 1, wherein said elongate slot in said base of said base of said tray extends from said open end at a peripheral edge to a closed end at a substantially central location thereon.

3. A timepiece according to claim 2, wherein said elongate slot in said faceplate of said face assembly extends from an open end at a peripheral edge to a closed end at a substantially central location thereon, the shape and principal dimensions of said faceplate and said base being substantially the same.

4. A timepiece according to claim 1, including at least one guide for guiding said face assembly into and out of said enclosure.

5. A timepiece according to claim 4, wherein said guide comprises at least one elongate ridge on one of said tray and said back plate, and at least one corresponding elongate groove in the other of said tray and said back plate, wherein, in use, said ridge is received in said groove to guide sliding movement of said tray into or out of said housing.

6. A timepiece according to claim 5, wherein said ridge is formed on a lower surface of said tray, when the timepiece is oriented for use, and said groove is formed in an upper surface of said back plate.

7. A timepiece according to claim 5, wherein said guide comprises a pair of substantially parallel, spaced apart ridges on one of said tray and said back plate and a pair of substantially parallel, spaced apart corresponding elongate grooves in the other of said tray and said back plate.

8. A timepiece according to claim 1, wherein said tray is provided, at a peripheral edge substantially opposite said open end of said slot, with a rim that extends around a portion of the periphery of said base.

9. A timepiece according to claim 8, wherein said rim of said tray closes said opening in said rim of said housing when said face assembly is fully inserted therein.

10. A timepiece according to claim 9, wherein said rim of said tray is formed of a resiliently flexible material and said rim of said housing is profiled to receive said rim of said tray such that it is retained therein by means of an interference fit.

11. A timepiece according to claim 1, wherein said tray includes, at a peripheral edge of said base adjacent to said open end of said slot, at least one engaging means configured to releasably engage with said rim of said housing when said face assembly is fully inserted into said housing, the timepiece further comprising external release means for releasing said engaging means and allowing the face assembly to be removed from said housing.

12. A timepiece according to claim 11, wherein said engaging means comprises at least one tooth member, and wherein an inner surface of said rim of said housing is provided with a recess configured to receive said tooth member therein when said face assembly is fully inserted within said housing.

13. A timepiece according to claim 11, wherein said rim of said housing includes an aperture adjacent said engaging means when said face assembly is fully inserted in said housing, said aperture extending through said rim of said housing and being configured to receive a tool for pushing said face assembly in the direction of said opening and, thereby, releasing said face assembly for removal from the housing.

14. A timepiece according to claim 1, further comprising an intermediate plate, located between said back plate and said face assembly, said intermediate plate comprising a substantially planar surface and having a generally central opening therein for accommodating at least a portion of said horological mechanism.

15. A timepiece according to claim 14, wherein said intermediate plate further comprises a groove or recess for accommodating a control member that is coupled between said time display means and an external location on said housing.

16. A face assembly for a timepiece according to claim 1, comprising a tray and a faceplate, the tray comprising a substantially rigid base and having an elongate slot therein that extends from an open end at a peripheral edge of the base to a generally central location thereof, the slot having a width substantially equal to, or greater than, the diameter of said shaft, the faceplate having a corresponding elongate slot therein and being configured to be received on said base such that their respective elongate slots are aligned.

17. A faceplate for a face assembly according to claim 16.
